(19) United States
(12) Patent Application Publication
(10) Pub. No.: US 2017/0022463 A1
(43) Pub. Date: Jan. 26, 2017

(54) DEVICE AND METHOD FOR PRODUCING BEER

(71) Applicant: GranMalt AG, Freising (DE)

(72) Inventor: Gerhard Kamil, Bergkirchen (DE)

(21) Appl. No.: 15/286,075

(22) Filed: Oct. 5, 2016

Related U.S. Application Data
(63) Continuation of application No. PCT/EP2015/057614, filed on Apr. 8, 2015.

(30) Foreign Application Priority Data
Apr. 10, 2014 (EP) 14164312.2
Apr. 11, 2014 (EP) 14164414.6

(51) Int. Cl. C12C 11/11; B65D 85/804; C12C 12/00

(52) U.S. Cl. CPC C12C 11/11; C12C 12/00; B65D 85/8043

(57) ABSTRACT

The invention relates to a method for producing beer from beer granulate according to the following steps, in any order: the beer granules are dissolved in water, carbon dioxide is dissolved in the water.

### CROSS-REFERENCE TO RELATED APPLICATIONS

This application is a continuation of pending International Application No. PCT/EP2015/057614 filed on Apr. 8, 2015, which designates the United States and claims priority from the European Application No. 14164312.2 filed on Apr. 10, 2014 and European Application No. 14164414.6 filed on Apr. 11, 2014. The disclosure of each of the above-referenced documents is incorporated herein by reference

### BACKGROUND

1. Field of the Invention

The invention relates to to the production of beer, in particular the production of beer from beer granulate.

2. Description of Relevant Art

Beer granulate is a granular or sometimes as well powdered product, which, when dissolved in water, gives it a beer-like taste. Beer granulate is known per se and can be obtained from beer, for example, by fluidized bed granulation. However, beer granulate can also be produced synthetically. Only to name an example, reference is made to DE 101 20 979. However, beer granulate does not contain alcohol. Beer granulate has heretofore only been used aside from laboratories only to make relatively large quantities of “beer” storable or to transport “beer” cost-effectively over large distances. In both cases, the finished beer was industrially prepared and filled as usual into bottles or kegs.

### SUMMARY

The invention is based on the object of providing a device and a method for producing beer and a portion capsule for use with the device and the method for producing beer, in which the production of beer from beer granulate is moved into the kitchen or the living room of the consumer. In this case, typical drink portions, for example, 0.5 L (“half Mass”), a pint (“British pint”, approximately 0.568 L), or the like are to be provided per procedure.

The invention relates to a method for producing beer from beer granulate. The method for producing beer from beer granulate has at least the following method steps: dissolving beer granulate in water, preferably within a portion capsule; and dissolving carbon dioxide in the water.

Said dissolving of the beer granulate in the portion capsule takes place only a short time (a few seconds or minutes) before the planned consumption of the beer.

A person skilled in the art understands in this case that the term water also refers to water having beer granulate dissolved therein, i.e., in particular the beer granulate solution. Preferably, alcohol is added to the beer granulate solution to obtain alcoholic beer. In this case, the weight proportions of the water, the beer granulate, and the carbon dioxide are selected so that the alcohol proportion of the beer is between 0 and 10 vol. %, preferably between 0.5 and 6.5 vol. %, and particularly preferably between 3 and 5 vol. %. Of course, the alcohol can also be added to the water before the production of the beer granulate solution.

Dissolving of beer granulate in water can take place at a temperature which is higher than room temperature, because the beer granulate then dissolves more easily, i.e., more rapidly. This temperature is preferably between 20® C. and 99° C., particularly preferably between 20° C. and 80° C., still more preferably between 20° C. and 50° C. Experiments using the portion capsule which is described hereafter had the result, however, that this heating is not necessary.

Said process of dissolving of carbon dioxide in water (which is interchangeably referred to herein by the term carbonation, which term designates, unless specifically stated otherwise, such process), can take place in particular with the aid of in-line carbonation or with the aid of so-called batch carbonation. In this case, it is preferable for the temperature of the water to be low, in particular lower than room temperature, because with decreasing temperature the water can dissolve more carbon dioxide.

The method preferably furthermore comprises adding alcohol to the water. The alcohol can be added either in liquid form or preferably as dry alcohol. When dry alcohol is added, which is often also referred to as alcohol powder, it dissolves in the water or the beer granulate solution, respectively. The addition of alcohol can therefore take place both before the dissolving of the beer granulate and also thereafter. However, if the addition of alcohol takes place before the dissolving of the beer granulate, then alcohol-soluble components of the beer granulate can be dissolved better in the alcohol-water mixture. Thus, for example, some flavors can thus be dissolved better at least in the water. Dry alcohol is understood as ethanol which is intercalated in dextrins (cf. in this regard U.S. Pat. No. 3,795,747). Or in other words, ethanol which is intercalated in dextrins is herein interchangeably referred to, unless specifically stated otherwise, by the term dry alcohol. Further the term dry alcohol herein comes under the subordinator concept of the term alcohol.

The portion capsule according to the invention is intended for use in particular with a method according to the invention for producing beer from beer granulate and/or in particular for use with a device according to the invention for producing beer from beer granulate and has at least one interior, for example, a chamber, which comprises beer granulate.

The beer granulate and also the alcohol can be stored in separate portion capsules for producing beer from beer granulate, water, carbon dioxide, and optionally alcohol. For example, a portion capsule containing beer granulate can then firstly be flushed out using a preferably heated first partial quantity of the water, to at least partially, preferably completely dissolve the beer granulate in this case. The part of the beer granulate which does not go into solution already in the capsule is flushed out of the capsule and subsequently dissolves. For this purpose, a device having at least one device, which fixes and opens the portion capsule at at least one, preferably at two positions, is preferably used. The device preferably has a receptacle in which the portion capsule is fixed. After the flushing out of the first portion capsule using the first partial quantity of the water, the first portion capsule can be removed from the device. It can be replaced with a second portion capsule containing alcohol. This second portion capsule is now also opened accordingly and the alcohol is removed and admixed with the water. For this purpose, the second portion capsule can be flushed out using the first partial quantity of water (now a beer granulate solution) and/or using another, preferably cooled partial quantity of water. Blowing out the second portion capsule using air or preferably carbon dioxide is also possible. The second portion capsule does not necessarily have to be accommodated in the same device as the first portion capsule. The removal of the alcohol from the second portion capsule can also be performed manually or by means of another device. In particular, the device can comprise at least two receptacles for one portion capsule each, wherein at least one receptacle is provided for a portion capsule containing beer granulate and at least one other receptacle is provided for a portion capsule containing alcohol. The portion capsules and the associated receptacles are preferably shape-coded to prevent the portion capsule containing alcohol from being inserted into the receptacle for portion capsules containing beer granulate or vice versa.

The device for producing beer and/or for dissolving the beer granulate thus preferably comprises at least one receptacle or chamber for fixing at least one portion capsule. The chamber preferably has at least one inlet for water and at least one outlet for the water admixed with the beer granulate, wherein the beer granulate at least partially already goes into solution in the portion capsule. The receptacle or the chamber, respectively, can be opened or closed, wherein the portion capsule is inserted and removed while the chamber is open and is secured, i.e., fixed therein when the receptacle or chamber, respectively, is closed.

The invention relates in particular to a portion capsule having an interior in which beer granulate is stored. Accordingly, the portion capsule has a wall, which delimits the interior and preferably encloses it airtight, i.e., encapsulates it. The portion capsule correspondingly has a bottom on which at least one side wall is attached or molded. For example, the side wall can be molded in one piece together with the bottom and can initially form a container which is open on top, and which is closed using a cover after filling.

The interior of the capsule is preferably divided by at least one membrane into at least two chambers. This enables two substances which are to be dissolved in the water to be arranged separately from one another in the portion capsule, i.e., the two substances can be prevented from influencing one another. For example, one substance can be a beer granulate and the other can be alcohol, in particular dry alcohol.

For example, the membrane can be arranged transversely to the flow direction provided later in the portion capsule. (It is presumed hereafter by way of example that the flow is to pass through the portion capsule from the cover to the bottom or vice versa). A first substance, for example, a predetermined quantity of beer granulate (or alcohol) is then firstly introduced into the still open portion capsule, subsequently the membrane is introduced above the beer granulate (or the alcohol) into the portion capsule. For example, the membrane can be laid on the substance. The edge of the membrane is preferably connected, for example, by compression, with the wall of the portion capsule. For example, the wall can have a groove, preferably a ring groove, in which an edge region of the membrane is inserted. If the groove is now compressed, the membrane is fixed therein and the regions above and below the membrane, i.e., the chambers, are reliably separated from one another.

The membrane can also be shaped molded as a container which is preferably open on top, and which is inserted above the first substance into the still open portion capsule. The second substance can now be introduced into this cavity thus formed. Upon closing of the cover, it is preferably connected to both the side wall and also the membrane. This can be performed, for example, by compressing or rolling in the corresponding edges. Of course, other connection techniques are also conceivable, for example, gluing or welding.

After the introduction and the optional fixation of the membrane, the second substance, i.e., the alcohol or the beer granulate, respectively, can be introduced into the second chamber which is separated by means of the membrane.

In the same way, further chambers can be arranged by means of further membranes in the portion capsule.

The portion capsules can now be closed airtight using the cover (if no further substances are to be introduced into the portion capsules). The portion capsules are preferably flooded using carbon dioxide or nitrogen before being closed. Both gases increase the storability of the beer granulate and are also washed out and at least partially dissolved in the water during the later flushing of the portion capsule.

The at least one membrane is preferably water-soluble or water-permeable, so that substances arranged in the chambers can go into solution upon flushing of the portion capsule. Alternatively, the at least one membrane can be pierced before or during the flushing. This can be performed, for example, by at least one mandrel, which penetrates the membrane upon insertion of the portion capsule into a complementary receptacle of a device for producing beer. The at least one mandrel can also be coupled to a closing mechanism of the receptacle, to pierce through the membrane upon closing of the receptacle and to perforate it at the same time. The mandrel is preferably subsequently retracted. Of course, multiple mandrels located opposite to one another can also be arranged on the receptacle.

At least one mandrel can have an internal channel and can be used as a cannula for injecting water into the portion capsules, i.e., it can be connected to the corresponding feed line.

In a further embodiment, the membrane can be omitted, but then preferably only dry alcohol is to be used. This can also be mixed with the beer granulate before being filled into the interior of the portion capsule, without negatively influencing it.

As shown in the drawing, the membrane can also be arranged in parallel to the flow direction. The chambers thus formed can therefore be flushed using water of different temperatures and also in a predefined sequence. Destruction of the membrane can then be omitted.

The through flow direction of the capsule during the flushing thereof is defined by the user and/or the device for this purpose for producing beer, of course. In practice however, capsule and device are necessarily complementary to one another, so that the capsule has a predefined flow direction, i.e., the through flow of the water during flushing of the capsule is predefined by the capsule. The capsule preferably has a cross section which tapers in the flow direction, to also reliably flush out the region of the bottom.

In the scope of this application, the terms water and/or water quantities are used repeatedly. In this case, the water is primarily typical drinking water, to which further ingredients are added, for example, by flushing of the portion capsules. Strictly speaking, after further ingredients have been added to the water, the corresponding intermediate products therefore have to be referred to as an aqueous solution, but after all it is always the water to which further substances are added to finally become a beer or beer-like beverage.

### BRIEF DESCRIPTION OF THE DRAWINGS

In the following, the invention will be described by way of example, without limitation of the general inventive concept, on examples of embodiment and with reference to the drawings.

FIGS. 1, 2, 3, and 4 show methods according to embodiments of the invention.

FIGS. 5 and 6 show devices according to embodiments of the invention.

FIGS. 7, 8, and 9 show portion capsules according to embodiments of the invention for use with a method according to the embodiments of FIGS. 1 to 4 or a device according to the embodiments of FIG. 5 or 6.

While the invention can be modified without changing its scope and can take alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

A method according to an embodiment the invention is shown in FIG. 1. After beginning the method, the provision of water is performed in step 100, the dissolving of beer granulate in the water is performed in step 110, and the dissolving of carbon dioxide in the water is performed in step 120. According to another embodiment, the sequence of steps 110 and 120 can also be performed in reversed order.

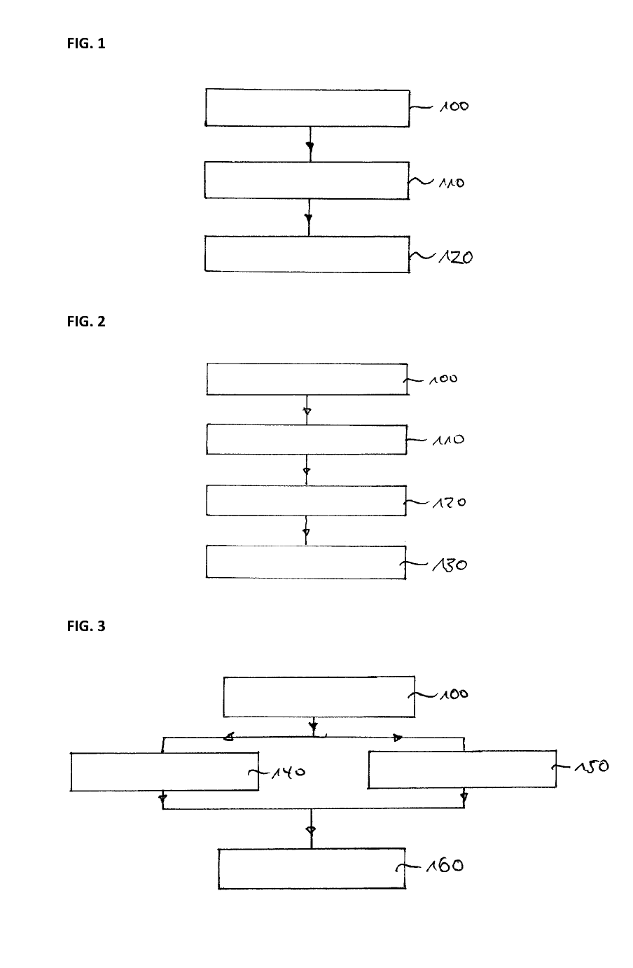

After the beginning of the method according to FIG. 2, the provision of water is performed in step 100, the dissolving of beer granulate in the water is performed in step 110, the dissolving of carbon dioxide in the water is performed in step 120, and the addition of alcohol to the water is performed in step 130. According to another embodiment, step 130 can be performed between steps 100 and 110 or between steps 110 and 120. In this embodiment, steps 110 and 120 can also run in the reverse sequence. In other words, the three method steps 110, 120, and 130 can be carried out in any arbitrary permutation. As already described above, however, the alcohol is preferably firstly added and the beer granulate is subsequently dissolved.

After the beginning of the method according to FIG. 3, the provision of water is performed in step 100. After step 100, branching off of a first partial quantity of the water and dissolving of the beer granulate in the first partial quantity are performed in step 140. The first partial quantity of the water can be heated beforehand. Experiments have surprisingly shown, however, that the portion capsules described hereafter can also be reliably flushed out using unheated water. “Unheated” here means water having the temperature from which it is taken from the typical domestic water supply (typically approximately 4° C. in northern Europe to 25° C. in southern Europe). Carbon dioxide is dissolved in another partial quantity of the water, which is preferably cooled beforehand, in step 150. Steps 140 and 150 can run simultaneously, but can also run in any sequence in succession in another embodiment. After steps 140 and 150 have both occurred, mixing of the partial quantities obtained by steps 140 and 150 takes place in step 160. Nonalcoholic beer is thus obtained. After step 100, the water can also be separated into two different partial quantities.

To obtain alcoholic beer, according to a further embodiment, alcohol is added to the water at any point of the method just described. This can take place, for example, directly after step 100, before or during step 140 or 150, or also before, during, or after step 160. It is also possible to add a quantity of alcohol to each of the two partial quantities.

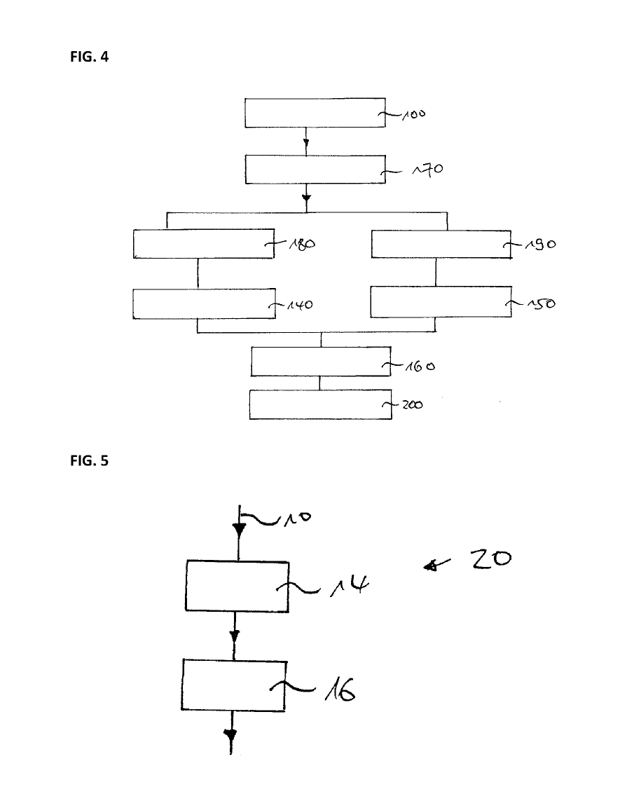

After beginning the method according to FIG. 4, the provision of water is performed in step 100. After step 100, the water is separated into two different partial quantities in step 170.

The first partial quantity of water is then heated to a temperature T1 in step 180 and beer granulate is dissolved in the first partial quantity of water in step 140.

The second partial quantity of water is cooled to a temperature T2 in step 190 and carbon dioxide is preferably subsequently dissolved in the second partial quantity of water in step 150.

Steps 180 and 140 and also steps 190 and 150 can run simultaneously or in succession in any sequence.

After steps 180 and 140 and also steps 190 and 150 have all been carried out, mixing of the first partial quantity of water (beer granulate solution) obtained by steps 180 and 140 and the second partial quantity of water obtained by steps 190 and 150 takes place in step 160. Nonalcoholic beer is thus obtained. After step 160, adding of alcohol to obtain alcoholic beer is performed in step 200. According to another embodiment, alcohol can also be added at other points of the method, for example, before the carbonation.

According to an embodiment, temperature T1 is between 20° C. and 98° C., preferably between 30° C. and 80° C., and particularly preferably between 30° C. and 60° C. If the alcohol is added prior to dissolving of the beer granulate, T1 is preferably to be less than the boiling temperature of ethanol.

According to a further embodiment, temperature T2 is between 0° C. and 20° C., preferably between 0° C. and 10° C., or between 4° C. and 10° C. and particularly preferably between 0° C. and 5° C.

The volumes of the first and second partial quantities and temperatures T1 and T2 are preferably adapted such that the mixing temperature is between 4° C. and 14° C. The resulting mixing temperature corresponds to the desired drinking temperature of the produced beer.

According to a further aspect, an embodiment of the invention furthermore relates to a device 20 for producing beer from beer granulate having a device 14 for dissolving the beer granulate in water and a device 16 for dissolving carbon dioxide in the water. Nonalcoholic beer is obtained using this device. To obtain alcoholic beer, the device preferably furthermore has a device 18 for adding alcohol to the water.

FIG. 5 shows a device 20 for dissolving the beer granulate in water. The device 20 has a water line 10, which transports water to the device 14 for dissolving the beer granulate in water and is connected to an inlet of the device 14. The outlet of the device 14 is connected to an inlet of the device 16 for dissolving carbon dioxide in the water. Nonalcoholic beer is obtained at the outlet of the device 16 for dissolving carbon dioxide or, if alcohol is also added in the device 14 for dissolving the beer granulate, alcoholic beer is obtained.

The device 20 preferably has a storage container for preferably cooled and/or carbonated water from which the second partial quantity is taken and is supplied to the mixer or the device 14 for dissolving the beer granulate via corresponding lines. The storage container preferably has a cooler or insulation. The carbonation can be performed outside or also inside the storage container in a batch process.

This is substantially simpler and therefore more cost-effective than inline carbonation and/or pass-through cooling. In addition, less space is required.

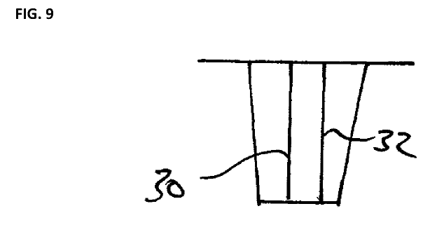

The device 14 for dissolving the beer granulate preferably has a chamber for securing at least one portion capsule containing beer granulate, for example, by clamping or enclosing the portion capsule using a wall of the chamber. As shown in FIGS. 8 and 9, the portion capsule can have multiple chambers, which enables it to dissolve not only beer granulate, but rather also alcohol.

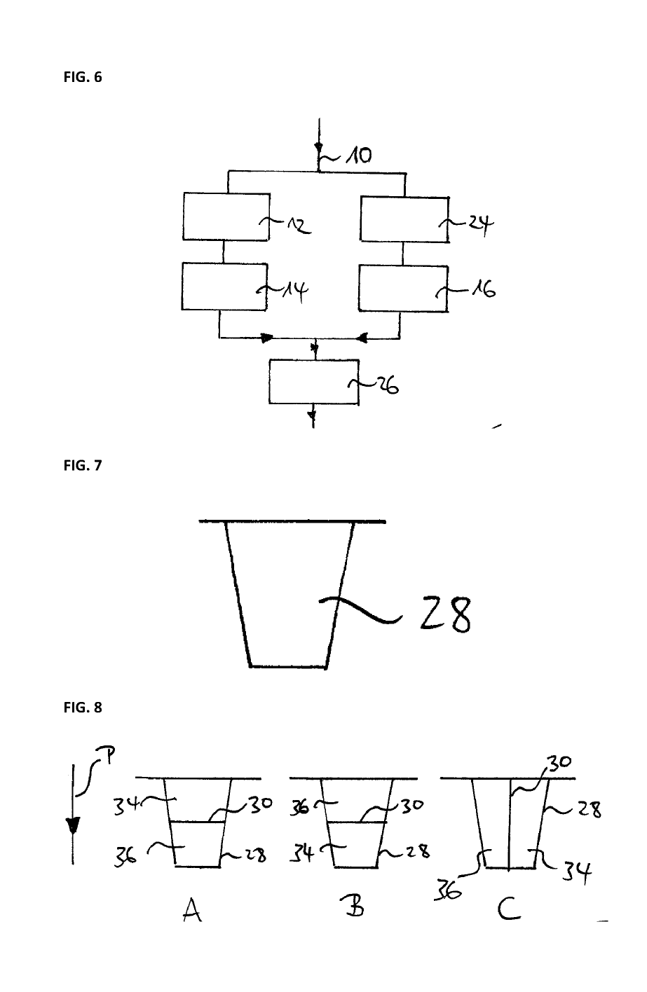

FIG. 6 shows a device 20 for dissolving the beer granulate in water. The device 20 has a water line 10, which splits water into a first partial quantity of water and a second partial quantity of water. The first partial quantity of water flows to a heating device 12 and the second partial quantity of water flows to a cooling device 24. In this case, the ratio of the first to the second partial quantity of water can be set arbitrarily. The heating and/or the cooling devices can also be omitted.

The heating device 12 heats the first partial quantity of water to a temperature T1, while the cooling device 24 cools the second partial quantity of water to a temperature T2.

The heated first partial quantity of water then flows out of the heating device 12 into the device 14 for dissolving the beer granulate in the first partial quantity of water, to therefore dissolve the beer granulate, which was previously contained in at least one portion capsule.

The cold second partial quantity of water flows from the device 24 into the device 16 for dissolving the beer granulate and causes post-flushing of the portion capsule. Alternatively, the second partial quantity can also be supplied past the device 16 to a mixer, in which the second partial quantity is mixed with the first partial quantity. The beer thus obtained can be discharged from the mixer via an outlet.

The possibly heated first partial quantity of water, which is admixed with beer granulate, and the second partial quantity of water, which is cooled and admixed with carbon dioxide, are then mixed in a mixing device 26, which is connected to the outlets of the devices 14 and 16. According to a further embodiment, in addition to the first and second partial quantities of water, alcohol can also be admixed in the mixing device 26, which is introduced via a further line into the mixing device. Alternatively, the alcohol can also already be added in the device 16, for example, by using the capsules shown in FIGS. 8 and/or 9. Mixing of the three liquids results in the final product beer, which is then conveyed further to the outlet of the mixing device. It can be taken from there by the consumer.

The method according to the invention for producing beer from beer granulate is preferably carried out with the aid of a portion capsule 28.

In this case, the portion capsule 28 can comprise beer granulate, in particular contain it exclusively. The intermediate spaces between the beer granulate particles are preferably filled with carbon dioxide or an inert gas. The latter case is shown in FIG. 7. In this case, the device 14 for dissolving the beer granulate in water can comprise the portion capsule. For example, the water is then supplied through a first opening of the portion capsule, the mixture of the beer granulate with the water is flushed out of a second opening of the portion capsule. The carbon dioxide and the alcohol can then be admixed according to FIG. 6.

In short, the term flushing the portion capsule is understood in particular to mean: if not provided, providing at least one first opening of the otherwise preferably closed portion capsule, supplying the water through the first opening and preferably providing at least one second opening (if not provided) to draw off the water having the at least partially dissolved beer granulate through the second opening. Subsequently, the portion capsule can be removed and replaced by a new portion capsule containing beer granulate. This can be flushed in the same manner.

In addition, the portion capsule 28 having beer granulate can have two chambers, which are preferably separated by means of a first membrane 30. The first membrane 30 is preferably fastened at two opposing ends on the wall of the portion capsule 28. The first membrane therefore separates two chambers of the portion capsule, so that two “beer components”, which are only storable separately, can be stored in a predetermined ratio in only one portion capsule. For example, one chamber can contain alcohol, in particular dry alcohol, and the other chamber can contain beer granulate.

FIG. 8 shows three possible embodiments of such a portion capsule 28.

In the portion capsule 28 shown in FIG. 8, water preferably flows along the direction shown in FIG. 8, i.e., at least approximately perpendicularly in relation to the two end faces of the portion capsule 28. In this case, the first opening of the portion capsule 28 is located in the upper end face and the second opening of the portion capsule 28 is located in the lower end face.

FIGS. 8A and 8B show portion capsules 28, in which the first membrane 30 is arranged in each case perpendicularly to the through flow direction of the water and the membrane divides the capsules into two chambers. In the case of FIG. 8A, a beer granulate 34 is located above the first membrane 30, i.e., in the first of the two chambers viewed in the flow direction P, and the alcohol 36 is located below the first membrane 30 in the second chamber. The alcohol 36 can preferably be stored as so-called dry alcohol in the second chamber.

In the case of FIG. 8B, the alcohol 36 is located above the first membrane 30, i.e., in the first chamber, and the beer granulate 34 is located below the first membrane 30 in the second chamber.

In the case of FIG. 8C, the first membrane 30 extends in parallel to the through flow direction P of the water. In this case, the alcohol 36 is located on one side of the membrane 30 and the beer granulate 34 is located on the other side. Two chambers are again formed by the membrane, which are arranged in parallel to one another in the flow direction, however.

In the embodiment of FIG. 8, for example, preferably heated water can flow through the portion capsule 28 and therefore create noncarbonated beer. If water which is cooled before or after the portion capsule 28 is admixed with carbon dioxide, alcoholic beer is obtained. Preferably, cold carbonated water is admixed after the portion capsule 28, because in this case the beer granulate dissolves better in the preferably warm water and the carbon dioxide dissolves better in the preferably cold water.

One chamber can preferably contain carbon dioxide. Carbon dioxide is preferably admixed in the chamber which contains alcohol. According to another embodiment, the chamber of the portion capsule 28 which contains beer granulate has carbon dioxide.

In the case of FIGS. 8A and 8B, the first membrane preferably dissolves when water comes into contact with it or in the event of mechanical pressure. For example, the first membrane can burst under a predetermined pressure, i.e., in the event of a predetermined pressure gradient between the first chamber and the second chamber.

In the case of FIG. 8C, it is furthermore possible that the membrane remains intact and mixing first takes place outside the portion capsule 28. However, the first membrane 28 can also be destroyed and mixing already takes place inside the portion capsule 28. For this purpose, the membrane can have an intended breakpoint, which is broken, for example, by a compression of the capsule.

Furthermore, the portion capsule 28 can have three chambers. The portion capsule 28 preferably has a first membrane 30 and a second membrane 32. The first membrane 30 and a second membrane 32 are preferably planar and extend in parallel to one another. In this case, the first two chambers can comprise beer granulate 34 and alcohol 36 and the third chamber can comprise carbon dioxide.

In this case, water can be sent through the portion capsule 28 and alcoholic beer is obtained directly at the other end of the portion capsule 28. In this case, the membranes 30, 32 can both remain intact and also be destroyed. If they remain intact, mixing takes place outside the portion capsule 28. In this case, it is possible that water having different temperatures flows on three paths, i.e., flow paths through the portion capsule 28.

If the membranes 30, 32 do not remain intact, mixing already takes place inside the portion capsule 28, so that the alcoholic beer already results therein.

It will be appreciated to those skilled in the art having the benefit of this disclosure that this invention is believed to provide beer, being extractable at home from a capsule. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

10 Gantry
10 water supply line
12 heating device
14 device for dissolving the beer granulate in water
16 device for dissolving carbon dioxide in the water
18 device for adding alcohol to the water
20 device for producing beer from beer granulate
22 tube
24 cooling device
26 mixing device
28 portion capsules
30 first membrane
32 second membrane
34 beer granulate
36 alcohol
100 method steps of providing water
110 method step of dissolving beer granulate in water
120 method step of dissolving carbon dioxide in water
130 method step of adding alcohol to water
140 method step of mixing a partial quantity of the water with beer granulate
150 method step of mixing another partial quantity of the water with carbon dioxide
160 method step of mixing the partial quantities obtained by steps 140 and 150
170 method step of separating the water into two different partial quantities
180 method step of heating the first partial quantity of water to a temperature T1
190 method step of cooling the second partial quantity of water to a temperature T2
200 method step of adding alcohol
P flow direction, axis

1. A method for producing beer, having the following steps:
(a) storing a beer granulate in a portion capsule, and
(b) dissolving the beer granulate by flushing the portion capsule with at least a first quantity of water.

2. The method according to claim 1 wherein
said flushing includes at least one of
(i) mixing of alcohol, contained in the portion capsule, with and
(ii) dissolving of said alcohol in
the first quantity of water.

3. The method according to claim 1, further comprising dissolving carbon dioxide in the first quantity of water.

4. The method according to claim 1,
further comprising mixing the first quantity of water with a second quantity of water, said second quantity of water containing carbon dioxide previously dissolved therein.

5. The method according to claim 4, wherein
a temperature of the second quantity of water is below a temperature of the first quantity of water.

6. The method according to claim 1,
comprising at least one of the following:
(i)—heating the first quantity of water from a first initial temperature thereof to a temperature T1 prior to said dissolving the beer granulate, T1 being higher than the first initial temperature;
dissolving carbon dioxide in a second quantity of water; and
(ii)—cooling a second quantity of water from a second initial temperature to a temperature T2 that is lower than the second initial temperature; and
dissolving carbon dioxide in said second quantity of water at the temperature T2 after said cooling;
and further comprising
mixing the first quantity of water, in which the beer granulate has been dissolved, with the second quantity of water, in which the carbon dioxide has been dissolved, to form a mixture at a mixing temperature.

7. The method according to claim 6, wherein
volumes of the first and second quantities of water and the temperatures T1 and T2 are chosen to obtain the mixing temperature between 4° C. and 14° C.

8. The method according to claim 1, wherein the beer granulate and alcohol are stored in the portion capsule that has at least two chambers, wherein the beer granulate and the alcohol are stored in separate chambers of said at least two chambers.

9. The method according to claim 8, further comprising storing carbon dioxide in one of said at least two chambers.

10. A device for producing beer, comprising:
at least one device for dissolving a beer granulate in a first quantity of water, said at least one device for dissolving the beer granulate having at least one closable receptacle for a portion capsule containing at least said beer granulate,
wherein the at least one device for dissolving beer granulate has
(i) at least one water supply line, which opens, on a supply side of said at least one device, into the at least one closable receptacle, and
(ii) a line configured to discharge water having the beer granulate from the at least one closable receptacle on an outlet side of the at least one device for dissolving the beer granulate,
to enable a flushing of the portion capsule arranged in the receptacle.

11. The device for producing beer according to claim 10, further comprising a device for dissolving carbon dioxide in a second quantity of water.

12. The device according to claim 11, wherein the at least one device for dissolving the beer granulate in the first quantity of water is arranged in parallel to or upstream from the device for dissolving carbon dioxide.

13. The device according to claim 12, further comprising a mixer configured to mix the first and second quantities of water provided, respectively, by operation of the at least one device for dissolving the beer granulate and the device for dissolving carbon dioxide.

14. The device according to claim 11, further comprising at least one of
(a) a device configured to heat the first quantity of water to a temperature T1, and
(b) a device configured to cool the second quantity of water to a temperature T2.

15. The device according to claim 13, further comprising
at least one first thermostat configured to set the temperature T1 between 20° C. and 78° C. and at least one second thermostat configured to set the temperature T2 between 0° C. and 20° C.

16. A portion capsule, wherein
the portion capsule has an encapsulated interior, the encapsulated interior enclosing a beer granulate.

17. The portion capsule according to claim 16, wherein the interior of the portion capsule is divided into at least two chambers being separated by at least one first membrane, wherein the beer granulate is arranged in one of the at least two chambers and alcohol is arranged in another of the at least two chambers.

18. The portion capsule according to claim 17, wherein
the portion capsule has a cover, a bottom, and an axis transverse to said cover and bottom; and
the at least one first membrane is arranged either in parallel or perpendicularly to said axis.

19. The portion capsule according claim 17, wherein the at least two chambers includes at least first, second, and third chambers and wherein carbon dioxide is arranged in another of said at least first, second, and third chambers.

20. The portion capsule according to claim 19, wherein
a second membrane is extended parallel to the at least one first membrane inside the capsule to thereby provide three chambers inside the capsule.
